(19) United States
(12) Patent Application Publication
(10) Pub. No.: US 2005/0218035 A1
(43) Pub. Date: Oct. 6, 2005

(54) Infrared transmissive integrated circuit socket cap

(76) Inventors: Tom E. Pearson, Beaverton, OR (US); Robert R. Martinson, Beaverton, OR (US); Terry Dishongh, Portland, OR (US)

Correspondence Address: TROP PRUNER & HU, PC, 8554 KATY FREEWAY, SUITE 100, HOUSTON, TX, 77024, US

(21) Appl. No.: 10/814,528

(22) Filed: Mar. 31, 2004

(51) Int. Cl. H02H 7/06; H02P 11/00

(52) U.S. Cl. 206/723; 206/724

(57) ABSTRACT

A cap may be provided over the hinged cover of an integrated circuit socket to be surface mounted to a printed circuit board. The cap may protect the socket prior to the insertion of the integrated circuit. It may also facilitate the surface mounting of the socket to a printed circuit board. It may do so in at least two ways. The cap may facilitate convective heating by the provision of a series of openings in the cap. The cap may also be infrared transmissive so that infrared radiation from a surface mount oven passes through the cap to heat the socket. As a result, in some embodiments, better reflow is achieved and higher solder ball reliability may result.

### BACKGROUND

This invention relates generally to socket caps for integrated circuits and, particularly, for integrated circuit microprocessors.

A microprocessor may be secured to a printed circuit board, such as a motherboard, through a socket. The socket may include pins that make electrical connections to the integrated circuit contacts and solder balls which electrically and mechanically secure the socket and the processor to the circuit board.

Conventionally, surface mount technique are utilized to secure the socket in place to the circuit board. To this end, the socket is positioned appropriately on the circuit board and heat is applied using a surface mount reflow oven. The surface mount reflow oven provides both infrared and convective heating.

Prior to the insertion of the processor into the socket and while the socket is being secured to the board, the top side of the socket may be protected by a plastic cap. Conventionally, that plastic cap is removably securable over the socket. Once the socket has been surface mounted to the printed circuit board and the processor is ready to be installed, the cap may be removed.

Generally, a microprocessor manufacturer may provide an integrated circuit chip to an original equipment manufacturer, such as a personal computer manufacturer or a motherboard manufacturer. The original equipment manufacturer or other installer surface mounts the package to an appropriate printed circuit board. To this end a surface mount reflow oven is utilized. It has been learned that in many cases, it is necessary to apply undesirably high heat in order to get reflow of the solder balls used in the surface mount connection. The socket, in some cases, acts as a heat sink and prevents the solder balls from reflowing fast enough in the desired reflow profile. As a result, the solder joints may not receive enough heat, causing solder joint reliability issues.

Thus, there is a need for better ways to surface mount sockets to printed circuit boards.

### BRIEF DESCRIPTION OF THE DRAWINGS

FIG. 1 is an enlarged, perspective view of one embodiment of the present invention;

FIG. 2 is an enlarged, exploded perspective view in accordance with one embodiment of the present invention;

FIG. 3 is an enlarged, top plan view of a cap in accordance with one embodiment of the present invention;

FIG. 4 is a cross-sectional view taken generally along the line 4-4 in FIG. 3;

FIG. 5 is a cross-sectional view taken generally along the line 5-5 in FIG. 4;

FIG. 6 is a cross-sectional view taken generally along the line 6-6 in FIG. 3;

FIG. 7 is a cross-sectional view taken generally along the line 7-7 in FIG. 6;

FIG. 8 is an enlarged, plan view of the inside of the cover of the socket shown in FIG. 1 in accordance with one embodiment of the present invention;

FIG. 9 is a schematic depiction of the process of surface mounting the socket to a printed circuit board in accordance with one embodiment of the present ivnetion;

FIG. 10 is a partial, cross-sectional view of the process of surface mounting the socket to a printed circuit board in accordance with one embodiment of the present invention;

FIG. 11 is an enlarged, cross-sectional view corresponding to FIG. 10 of another embodiment of the present invention; and

FIG. 12 is a cross-sectional view of a cap in accordance with still another embodiment of the present invention.

### DETAILED DESCRIPTION

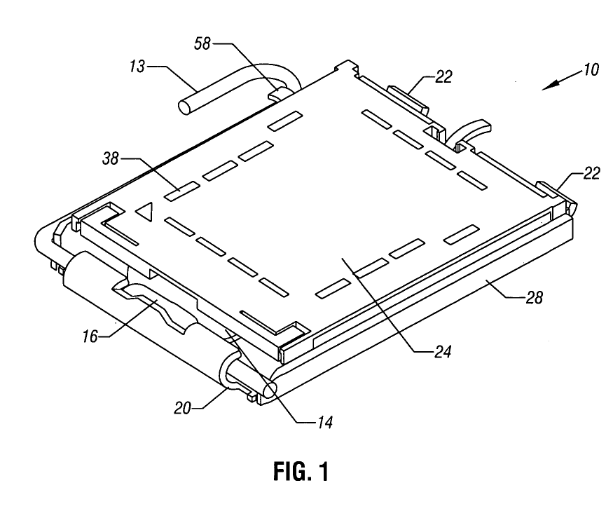

Referring to FIG. 1, a processor socket 10 may be an LG775 socket, also known as a socket T, in accordance with one embodiment of the present invention. It includes a socket housing 28 which is hingedly connected to a socket cover 14. The socket cover 14 may in turn be itself covered by an infrared transmissive cap 24.

The cover 14 may include curved prongs 22 which engage the housing 28 to allow pivotal motion of the cover 14 relative to the housing 28. The housing 28 may include a bar 16 which removably latches the cover 14 in the closed position shown in FIG. 1. The bar 16 is integral with a lever arm 13 which may be pivoted to release the cover 14. When not in use, the cover 14 is locked closed by engaging the lever arm 13 under the catch 58. The lever arm 13 may be L-shaped in one embodiment and may be retained under a U-shaped portion 20 of the housing 28.

The cap 24 may be formed of an infrared transmissive material. In one embodiment, the cap 24 transmits 80% of incident infrared radiation and, in a more advantageous embodiment, transmits 90% of incident infrared radiation. Among the materials that may be useful are plastic, glass, ceramics, and organic materials that are transparent or translucent to infrared radiation. Advantageously, the cap 24 may be made of a clear or translucent material which transmits infrared radiation. It may also be dark red translucent material since dark red is infrared transmissive, generally. The cap 24 may also include a plurality of peripherally situated slots 38 which allow air communication into the region underneath the cap 24.

The cap 24 may have two functions. It may perform the traditional cap function of preventing contamination or damage to socket 10 leads from the manufacturing processes up until the time the cap 24 is removed and the processor is inserted. However, the cap 24 may also assist in facilitating surface mounting of the socket 10 to a printed circuit board.

By permitting the transmission of infrared light, conventional surface mount ovens may more effectively heat solder balls to surface mount the socket 10 to a printed circuit board. Conventional surface mount ovens may supply both convective heat and infrared heat. Conventional caps tend to block the infrared heating. As a result, ineffective heating may occur, resulting in solder ball reliability problems.

The provision of the openings 38 may improve convective heat transfer through the cap 24 to the underlying solder balls in some cases. In one embodiment of the present invention, using a red translucent plastic cover, 95 percent of the infrared radiation penetrates the cap 24 without reflection or absorption. The infrared radiation may pass through the cap 24 to become absorbed by the socket leads which are thermally attached to solder balls at the bottom of the socket 10. This allows the solder balls to reach higher reflow temperatures faster, permitting the socket 10 to stay within the desired reflow specifications. Excessive heating may adversely affect the socket 10 in some cases.

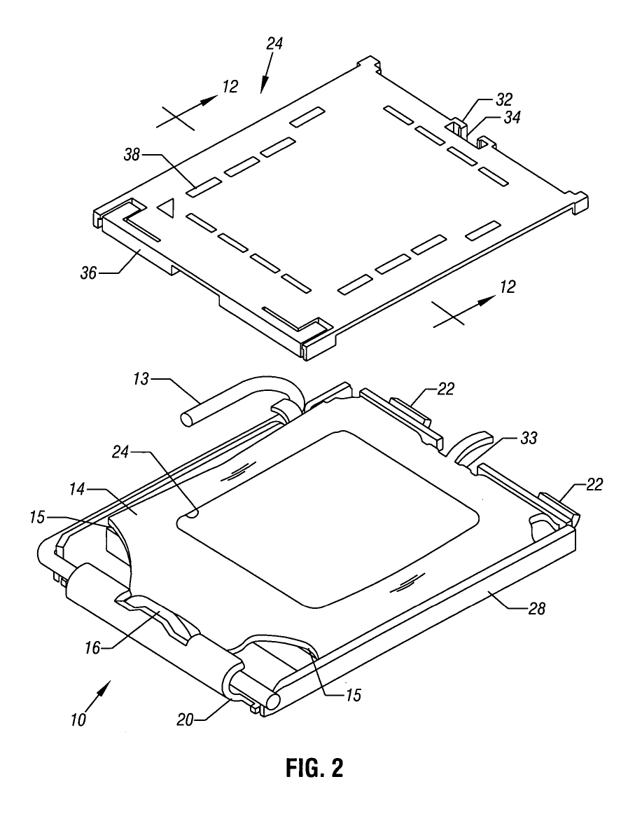

Referring to FIG. 2, the cap 24 may be removably secured to the cover 14 in one embodiment of the present invention. A plurality of tabs, including the spring based tabs 32, may releasably secure the cap 24 on the cover 14. An integrated circuit may protrude through opening 24 of the cover 14 after the socket 10 is surface mounted to a printed circuit board. As better seen in FIG. 2, the hook-like elements 22 engage appropriate slots in the housing 28 to provide a pivotal connection between the cover 14 and the housing 28.

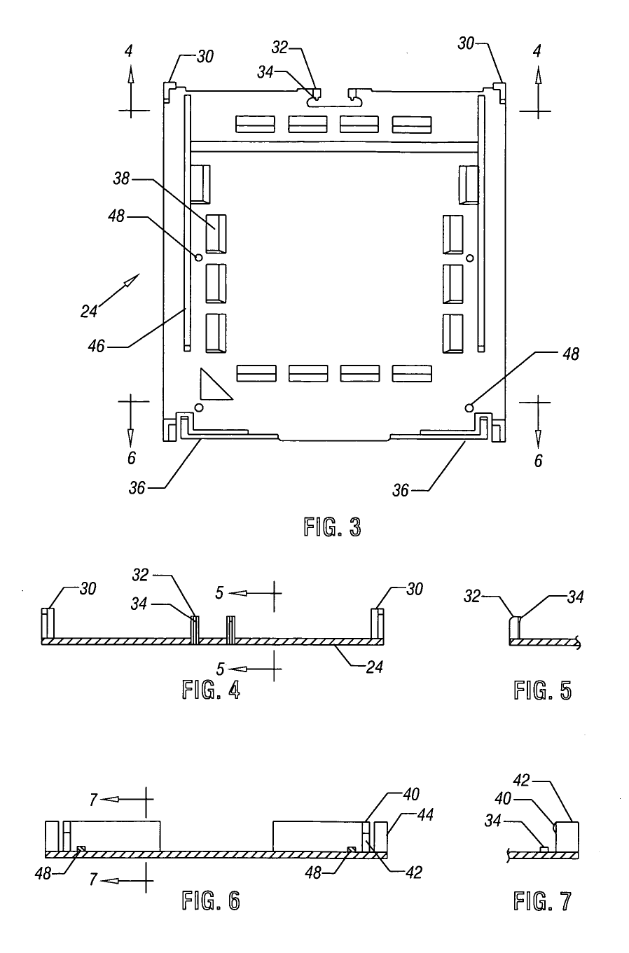

As better shown in FIG. 3, the underside of the cap 24 includes standoffs 46 and lands 48 to appropriately space the cap 24 from the underlying cover 14. In addition, the cap 24 may have a catch 34 mounted on a prong 32 to removeably secure the cap 24 to the cover 14 in a removable fashion. Thus, a pair of catches 34 may releasably engage the spaced portions 33 (FIG. 2) on the cover 14.

As shown in FIGS. 4 and 5, a catch 34 is positioned at the end of the prong 32 so as to engage the cover 14. At the same time on the opposite edge of the cap 24, as shown in FIGS. 3, 6, and 7, tabs 42 may releasably engage the cover 14. In particular, each upwardly extending tab 42 has a catch 40 on its free end to spring engage the opposite edge of the cover 14 in the region 15 (FIG. 2). In one embodiment, the tabs 42 may be mounted on the spring arms 36 which extend in an L-shaped arrangement. This allows spring adjustment in multiple directions of the engagement between the catch 40 and the portion 15 of the cover 14.

The alignment between the cap 24 and the cover 14 is facilitated by the guide 44 The guide 44 may serve to protect the element 42 and to guide the engagement of the cap 24 on the cover 14 in some cases.

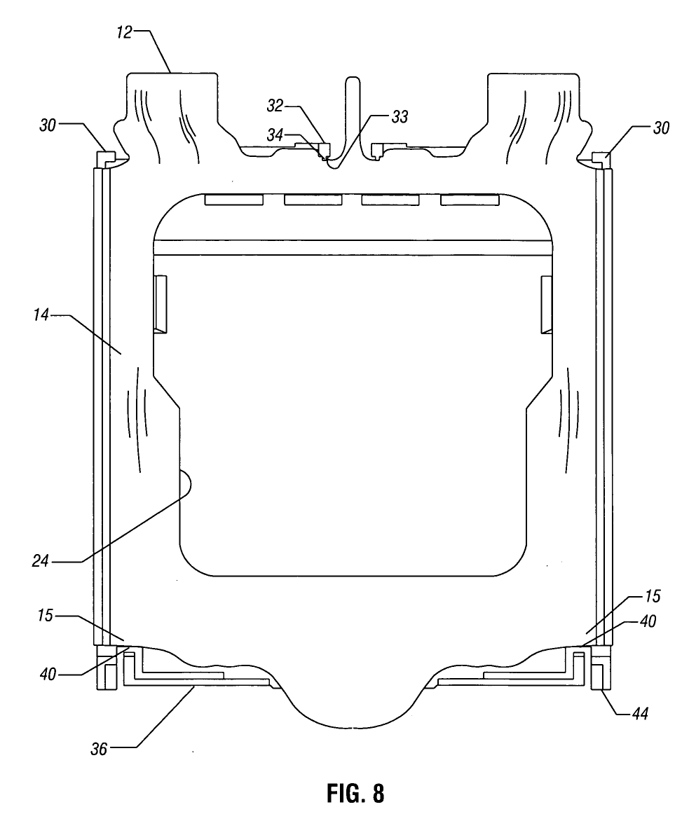

Thus, referring to FIG. 8, the catch 40 engages the cover 14 at the portion 15 on one edge, while the catch 34, on the opposite edge, engages the region 33 of the cover 14. In this case, no integrated circuit has yet been positioned so an opening 24 is unfilled in the cover 14.

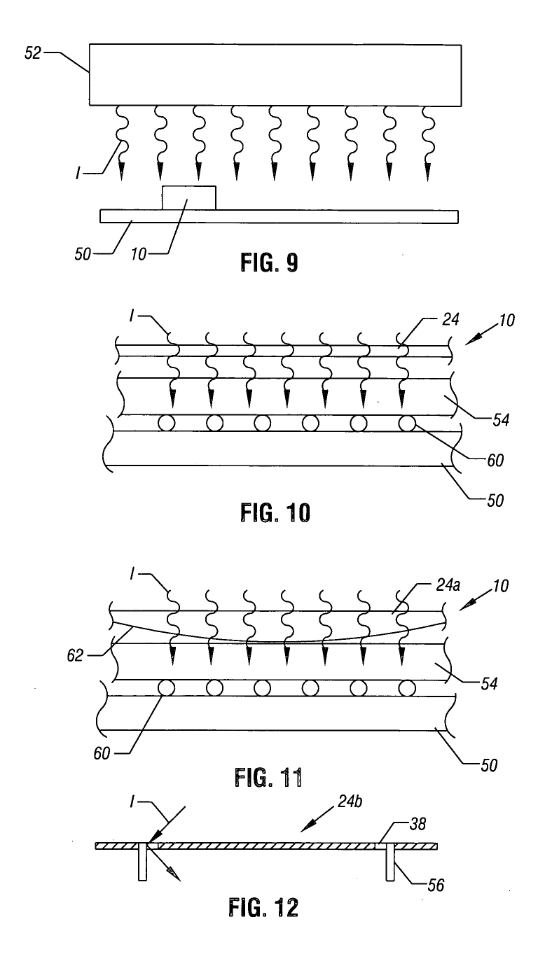

Referring to FIG. 9, a surface mount oven 52 may generate both convective heat and infrared radiation to surface mount a socket 10 on a printed circuit board 50. As shown in closer detail in FIG. 10, the infrared radiation I may penetrate into the socket portion 54 to heat the solder balls 60 and reflow them. The convective heating is facilitated by the openings 38 in the cap 24. Convective heat from the oven 52 may more readily pass through the openings 38 to access the interior regions proximate to the solder balls 60.

In accordance with another embodiment of the present invention shown in FIG. 11, the underside of the socket 24a may be curved. This curvature may advantageously, in some embodiments, further enhance infrared heating. The curved surface 62 on the bottom of a cap 24a reflects the infrared energy back away from the cap lower surface.

In accordance with still another embodiment of the present invention, openings 38 in a modified cap 24b may have downwardly protruding tabs 56 that reflect infrared radiation I. The infrared radiation may be reflected by the tabs 56 and directed into the open region below the cap 24b.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. An integrated circuit socket comprising:
a socket housing;
a hinged cover secured to said housing; and
an infrared transmissive cap removably secured to said cover.

2. The socket of claim 1 wherein said cap includes a plurality of openings formed through the cover to allow the passage of heated air.

3. The socket of claim 1 including spring catches on opposed ends of said cap to removeably secure said cap to said cover.

4. The socket of claim 1 wherein said cap transmits at least 80 percent of incident infrared radiation.

5. The socket of claim 4 wherein said cap transmits at least 95 percent of incident infrared radiation.

6. The socket of claim 1 wherein said cap is formed of plastic.

7. The socket of claim 6 wherein said cap is formed of translucent red plastic.

8. The socket of claim 1 wherein said cap includes standoffs to space said cap from said cover.

9. The socket of claim 1 wherein said cap has a curved lower surface.

10. The socket of claim 1 wherein said cap includes at least two apertures and downwardly extending prongs extending away from said apertures to reflect incident radiation passing through said apertures.

11. A cap for an integrated circuit socket comprising:
a body having apertures therethrough, said body formed of a material that is infrared transmissive; and
tabs coupled to said body to removeably secure said body to an integrated circuit socket.

12. The cap of claim 11 wherein said tabs include spring catches on opposed ends of said cap to removeably secure said cap to said socket.

13. The cap of claim 1 wherein said cap transmits at least 80 percent of incident infrared radiation.

14. The cap of claim 13 wherein said cap transmits at least 95 percent of incident infrared radiation.

15. The cap of claim 11 wherein said cap is formed of plastic.

16. The cap of claim 15 wherein said cap is formed of translucent red plastic.

17. The cap of claim 11 wherein said cap includes standoffs to space said cap from said socket.

18. The cap of claim 11 wherein said cap has a curved side.

19. The cap of claim 11 wherein said apertures include downwardly extending prongs to reflect infrared radiation passing through said apertures.

20. The cap of claim 11 wherein said cap includes guides to guide said cap into alignment with said socket.

21. A method comprising:
securing an infrared transmissive cap to an integrated circuit socket;
exposing said cap and said socket to infrared energy; and
surface mounting said socket to a printed circuit board.

22. The method of claim 21 including exposing said cap and said socket to a surface mount reflow oven producing both infrared and convective heating.

23. The method of claim 21 including allowing heated air to circulate through said cap via apertures through said cap.

24. The method of claim 21 including providing an apertured, red plastic, infrared transmissive cap on said socket.

25. The method of claim 21 including enabling at least 80 percent of the infrared incident energy to pass through said cap to said socket.
